(19) United States
(12) Patent Application Publication
(10) Pub. No.: US 2017/0223980 A1
(43) Pub. Date: Aug. 10, 2017

(54) METHOD OF MASKING OFF-TASTES WITH CELLOBIOSE AND/OR PSICOSE

(71) Applicant: Givaudan, S.A., Vernier (CH)

(72) Inventors: Ioana Maria UNGUREANU, Cincinnati, OH (US); Esther VAN OMMEREN, Almere (NL)

(21) Appl. No.: 15/497,614

(22) Filed: Apr. 26, 2017

Related U.S. Application Data
(63) Continuation-in-part of application No. PCT/EP2016/075209, filed on Oct. 20, 2016.
(60) Provisional application No. 62/244,819, filed on Oct. 22, 2015.

(51) Int. Cl. A23F 5/40; A23L 27/30

(52) U.S. Cl. CPC A23F 5/40; A23L 27/33; A23V 2002/00

(57) ABSTRACT

A method of masking off-tastes in a comestible composition, comprising the addition to a comestible composition base comprising high-intensity sweetener, of from 20-50 ppm of at least one of cellobiose and psicose. The use of one or both of the materials is effective particularly in masking the off-tastes encountered with the use of high-intensity sweeteners. In a particular embodiment, cellobiose and/or psicose may be used to block the off-tastes in reduced-sugar or no-sugar comestible products containing no high-intensity sweetener.

### CROSS REFERENCE TO RELATED APPLICATIONS

The present application is a continuation-in-part of international patent application PCT/EP2016/075209 filed Oct. 20, 2016, which claims priority from U.S. Provisional Application Ser. No. 62/244,819, filed Oct. 22, 2015, which applications are incorporated herein by reference.

This disclosure relates to a method of suppressing off-notes in high-intensity sweeteners.

Sweetness in comestible products, that is products intended to be taken by mouth either for permanent ingestion or temporarily for expectoration, is often a desirable characteristic. Traditionally, sweetness has been provided by the addition of a sweetening compound. Traditionally, this compound has been sucrose. Sucrose has the advantage of delivering considerable sweetness without any undesirable aftertaste. However, it is desired to use less sugar in health or dietary foods, which means in turn the possibility of a drop in sweetness that is unacceptable to consumers.

One way around this is the use of high-intensity sweeteners (HIS). These materials, which may be natural or artificial, have a sweetness which can be several hundred times that of sugar, and can thus theoretically stand in for a much larger quantity of sugar. Examples of typical HIS include saccharin, cyclamate, aspartame, stevioside, rebaudioside A (“Reb A”) and sucralose. These substances generally have the drawback that they impart undesirable off-tastes to comestible products, typically bitter or metallic tastes.

It has now been found that off-tastes in comestible compositions, whether or not containing high-intensity sweeteners, may be partially or even totally suppressed. There is therefore provided a method of masking off-tastes in a comestible composition, comprising the addition to a comestible composition base comprising high-intensity sweetener of from 20-50 ppm of at least one of cellobiose and psicose.

Cellobiose is a disaccharide of the formula

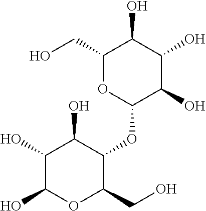 [SMILES: OC[C@H]1O[C@@H](O[C@H]2[C@H](O)[C@@H](O)[C@H](O)O[C@@H]2CO)[C@H](O)[C@@H](O)[C@@H]1O]

It is an enzymatic degradation product of cellulose, and it is readily available on industrial scale. It has a number of pharmacological uses.

Psicose, ribo-2-hexulose

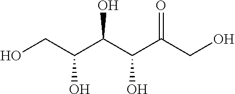 [SMILES: O=C(CO)[C@H](O)[C@H](O)[C@H](O)CO]

is a so-called “rare sugar”, which occurs to a slight extent in nature. It is an ultra-low-energy monosaccharide sugar, having lower sweetness than sucrose, but much lower caloric content and is therefore of interest for its potential in the reduction of sugar in dietary products. It was also recently approved as a sweetener in the US. Psicose exists in two forms, D-psicose and L-psicose. In a particular embodiment, the psicose is in the D-form.

PCT Publication WO 2007/061753 describes a functional sweetening composition, comprising glucosamine (the functional component), along with a high-intensity sweetener and additionally a sweet taste improving composition. The sweet taste improving composition can be selected from a wide variety of materials, including carbohydrates such as cellobiose and psicose.

However, the publication only exemplifies a small proportion of the vast range of sweet taste improving compositions and offers no guidance as to which composition will donate which characteristic in which circumstances. In addition, carbohydrates are stated to be required in concentrations of 1,000-100,000 ppm. It has been surprisingly found that cellobiose, psicose, or the two in combination, can be used with HIS to mask off-notes in concentrations much lower than previously expected. The use of cellobiose and psicose is completely interchangeable, and one can be used as a complete replacement for the other.

There is also provided a comestible composition comprising a comestible composition base, at least one sweetener and from 20-50 ppm of at least one of cellobiose and psicose.

By “comestible composition base” is meant all the ingredients necessary for the comestible composition, apart from the sweetener(s) and cellobiose/psicose. These will naturally vary in both nature and proportion, depending on the nature and use of the comestible composition, but they are all well known to the art and may be used in art-recognized proportions. The formulation of such a base for every conceivable purpose is therefore within the ordinary skill of the art.

The high-intensity sweetener useful in this disclosure may be any HIS suitable for conferring the desired level of sweetness on the composition. The HIS may be natural (modified or unmodified) or synthetic. Typical examples include examples including rebaudioside A, rebaudioside B, rebaudioside C, rebaudioside D, rebaudioside E, rebaudioside F, dulcoside A, dulcoside B, rubusoside, stevia, stevioside, mogroside IV, mogroside V, isomogroside V, Luo Han Guo sweetener, siamenoside, monatin and its salts (monatin SS, RR, RS, SR), curculin, glycyrrhizic acid and its salts, thaumatin, monellin, mabinlin, brazzein, hernandulcin, phyllodulcin, glycyphyllin, phloridzin, trilobatin, baiyunoside, osladin, polypodoside A, pterocaryoside A, pterocaryoside B, mukurozioside, phlomisoside I, periandrin I, abrusoside A, cyclocarioside I. aspartame, acesulfame-K, sucralose, saccharin, cyclamate, alitame, and advantame . Non-limiting examples of artificial sweeteners include saccharin, aspartame, sucralose, AceK™ and Neotame™.

The ingredients in a comestible composition base may include, but are not limited to, anti-caking agents, anti-foaming agents, anti-oxidants, binders, colourants, diluents, disintegrants, emulsifiers, encapsulating agents or formulations, enzymes, fats, flavour-enhancers, flavouring agents, gums, lubricants, polysaccharides, preservatives, proteins, solubilisers, solvents, stabilisers, sugar-derivatives, surfactants, sweetening agents, vitamins, waxes, and the like. Solvents which may be used are known to those skilled in the art and include e.g. ethanol, ethylene glycol, propylene glycol, glycerine and triacetin. Encapsulants and gums include maltodextrin, gum arabic, alginates, gelatine, modified starch, other polysaccharides, and proteins.

Examples of additives, excipients, carriers, diluents or solvents for flavour or fragrance compounds may be found e.g. in “Perfume and Flavour Materials of Natural Origin”, S. Arctander, Ed., Elizabeth, N.J., 1960; in “Perfume and Flavour Chemicals”, S. Arctander, Ed., Vol. I & II, Allured Publishing Corporation, Carol Stream, USA, 1994; in “Flavourings”, E. Ziegler and H. Ziegler (ed.), Wiley-VCH Weinheim, 1998, and “CTFA Cosmetic Ingredient Handbook”, J. M. Nikitakis (ed.), 1st ed., The Cosmetic, Toiletry and Fragrance Association, Inc., Washington, 1988.

Cellobiose, psicose and a mixture of these two compounds can be used alone or in a variety of combinations, with cellobiose making 0-100% of the mixture while the concentration of psicose equals 100% minus the percentage of psicose.

In a particular embodiment, one or both compounds may be added to a comestible composition as part of a flavour composition, that is a composition containing at least one flavour-providing ingredient, plus at least one ancillary ingredient, instead of the compounds being added as individual ingredients.

Non-limiting examples of suitable flavour-providing ingredients include natural flavours, artificial flavours, spices, seasonings, and the like. These include synthetic flavor oils and flavoring aromatics and/or oils, oleoresins, essences, and distillates, and combinations thereof.

Flavor oils include spearmint oil, cinnamon oil, oil of wintergreen (methyl salicylate), peppermint oil, Japanese mint oil, clove oil, bay oil, anise oil, eucalyptus oil, thyme oil, cedar leaf oil, oil of nutmeg, allspice, oil of sage, mace, oil of bitter almonds, and cassia oil; useful flavoring agents include artificial, natural and synthetic fruit flavors such as vanilla, and citrus oils including lemon, orange, lime, grapefruit, yuzu, sudachi, and fruit essences including apple, pear, peach, grape, raspberry, blackberry, gooseberry, blueberry, strawberry, cherry, plum, prune, raisin, cola, guarana, neroli, pineapple, apricot, banana, melon, apricot, cherry, tropical fruit, mango, mangosteen, pomegranate, papaya, and so forth.

Additional exemplary flavors imparted by a flavor-producing ingredient may include a milk flavor, a butter flavor, a cheese flavor, a cream flavor, and a yogurt flavor, a vanilla flavor, tea or coffee flavors, such as a green tea flavor, an oolong tea flavor, a tea flavor, a cocoa flavor, a chocolate flavor, and a coffee flavor; mint flavors, such as a peppermint flavor, a spearmint flavor, and a Japanese mint flavor; spicy flavors, such as an asafetida flavor, an ajowan flavor, an anise flavor, an angelica flavor, a fennel flavor, an allspice flavor, a cinnamon flavor, a chamomile flavor, a mustard flavor, a cardamom flavor, a caraway flavor, a cumin flavor, a clove flavor, a pepper flavor, a coriander flavor, a sassafras flavor, a savory flavor, a Zanthoxyli Fructus flavor, a perilla flavor, a juniper berry flavor, a ginger flavor, a star anise flavor, a horseradish flavor, a thyme flavor, a tarragon flavor, a dill flavor, a capsicum flavor, a nutmeg flavor, a basil flavor, a marjoram flavor, a rosemary flavor, a bayleaf flavor, and a wasabi (Japanese horseradish) flavor; a nut flavor such as an almond flavor, a hazelnut flavor, a macadamia nut flavor, a peanut flavor, a pecan flavor, a pistachio flavor, and a walnut flavor; floral flavors; and vegetable flavors, such as an onion flavor, a garlic flavor, a cabbage flavor, a carrot flavor, a celery flavor, mushroom flavor, and a tomato flavor.

According to some embodiments, flavor-producing ingredients may also include aldehydes and esters such as cinnamyl acetate, cinnamaldehyde, citral diethylacetal, dihydrocarvyl acetate, eugenyl 49 formate, p-methylamisol, and so forth can be used. Further examples of aldehyde flavourings include acetaldehyde (apple), benzaldehyde (cherry, almond), anisic aldehyde (licorice, anise), cinnamic aldehyde (cinnamon), citral, i.e., alpha-citral (lemon, lime), neral, i.e., beta-citral (lemon, lime), decanal (orange, lemon), ethyl vanillin (vanilla, cream), heliotrope, i.e., piperonal (vanilla, cream), vanillin (vanilla, cream), alpha-amyl cinnamaldehyde (spicy fruity flavours), butyraldehyde (butter, cheese), valeraldehyde (butter, cheese), citronellal (modifies, many types), decanal (citrus fruits), aldehyde C-8 (citrus fruits), aldehyde C-9 (citrus fruits), aldehyde C-12 (citrus fruits), 2-ethyl butyraldehyde (berry fruits), hexenal, i.e., trans-2 (berry fruits), tolyl aldehyde (cherry, almond), veratraldehyde (vanilla), 2,6-dimethyl-5-heptenal, i.e., melonal (melon), 2,6-dimethyloctanal (green fruit), and 2-dodecenal (citrus, mandarin), and the like.

Generally any flavor-producing ingredient or food additive such as those described in “Chemicals Used in Food Processing”, Publication No 1274, pages 63-258, by the National Academy of Sciences, can be used. This publication is incorporated herein by reference.

Ancillary ingredients may be present to provide other benefits such as enhanced stability, ease of incorporation into a comestible product and enhanced nutritional value. Non-limiting typical examples of such ancillary ingredients include stabilizers, emulsifiers, preservatives, gums, starches, dextrins, vitamins and minerals, functional ingredients, salts, antioxidants, and polyunsaturated fatty acids. Particular examples are emulsifiers and carriers, useful in spray drying processes. Non-limiting examples of these are modified starches, such as Capsul™, and maltodextrin.

The flavour compositions may be a simple blend of ingredients, or they may be encapsulated in any suitable encapsulant, such as those mentioned above. They may be prepared by any suitable method, such as kneading followed by comminuting, spray drying, extrusion and fluidised bed drying .

Cellobiose and cellobiose/psicose may be used in any kind of edible consumable product with or without HIS. In particular embodiments, when HIS is present, the HIS is selected from rebaudioside A and sucralose. It has been found that, in conjunction with these sweeteners, the desirable effects of cellobiose, psicose and cellobiose/psicose are especially enhanced.

Non-limiting examples of such comestible compositions include:
wet/liquid soups regardless of concentration or container, including frozen soups. For the purpose of this definition soup(s) means a food prepared from meat, poultry, fish, vegetables, grains, fruit and other ingredients, cooked in a liquid which may include visible pieces of some or all of these ingredients. It may be clear (as a broth) or thick (as a chowder), smooth, pureed or chunky, ready-to-serve, semi-condensed or condensed and may be served hot or cold, as a first course or as the main course of a meal or as a between meal snack (sipped like a beverage). Soup may be used as an ingredient for preparing other meal components and may range from broths (consommé) to sauces (cream or cheese-based soups).
dehydrated and culinary foods, including cooking aid products such as: powders, granules, pastes, concentrated liquid products, including concentrated bouillon, bouillon and bouillon like products in pressed cubes, tablets or powder or granulated form, which are sold separately as a finished product or as an ingredient within a product, sauces and recipe mixes (regardless of technology);
meal solutions products such as: dehydrated and freeze dried soups, including dehydrated soup mixes, dehydrated instant soups, dehydrated ready-to-cook soups, dehydrated or ambient preparations of ready-made dishes, meals and single serve entrees including pasta, potato and rice dishes
meal embellishment products such as: condiments, marinades, salad dressings, salad toppings, dips, breading, batter mixes, shelf stable spreads, barbecue sauces, liquid recipe mixes, concentrates, sauces or sauce mixes, including recipe mixes for salad, sold as a finished product or as an ingredient within a product, whether dehydrated, liquid or frozen.
beverages, including beverage mixes and concentrates, including but not limited to, alcoholic and non-alcoholic ready to drink and dry powdered beverages, carbonated and non-carbonated beverages, e.g., sodas, fruit or vegetable juices, alcoholic and non-alcoholic beverages, confectionery products, e.g., cakes, cookies, pies, candies, chewing gums, gelatins, ice creams, sorbets, puddings, jams, jellies, salad dressings, and other condiments, cereal, and other breakfast foods, canned fruits and fruit sauces and the like.
milk, cheese, yoghurt and other dairy products.

In a particular embodiment, cellobiose and/or psicose can remove the undesirable taste notes of certain comestible products that do not contain HIS, especially comestible products that have reduced or no sugar content (“sugar” in this case encompassing not only sugar (sucrose) but also low-intensity sweeteners such as high fructose corn syrup). A particular example is coffee, but other examples include oatmeal, yoghurt, especially zero-fat yoghurt, cocoa and orange juice.

As hereinabove described, the cellobiose and/or psicose may also form part of flavour compositions.

The disclosure therefore also provides a method of reducing the off-notes of comestible products having reduced or no sugar content and containing no HIS, comprising the addition to a comestible composition base of an off-note-masking proportion of cellobiose and/or psicose.

The disclosure also provides a reduced- or no-sugar comestible product containing no HIS, comprising a comestible product base and an off-note-masking proportion of cellobiose and/or psicose.

The reduced- or no-sugar comestible product containing no HIS may be selected from oatmeal, yoghurt, especially zero-fat yoghurt, cocoa and orange juice. In a particular embodiment, it is coffee.

The generally understood meaning in the art of “reduced sugar” is 2-7% sucrose equivalents (i.e. 2-7% by weight sucrose). 10% or more is considered “full sugar”.

The disclosure is further described with reference to the following non-limiting examples in which all parts, proportions and percentages are by weight, unless otherwise stated.

### EXAMPLE 1

In a strawberry-flavoured zero-fat yoghurt, sweetened with aspartame/AceK, psicose was tested at 50 ppm for masking of sweet lingering and other off-notes.

Samples were evaluated by a panel of 6 expert tasters. Tasters were asked to describe the samples focusing on the sweet lingering and other off-notes of HIS.

Base is 0% fat yoghurt , 100 ppm asapartame and 300 ppm AceK, proprietary strawberry flavour © 0.1%

Base: sweet, ripe strawberry, lingering sweet and licorice

Base plus 50 ppm psicose: reduction of sweet lingering off-notes, reduction of astringency, more strawberry impact, increase in mouthfeel

### EXAMPLES 2-8

Masking examples of cellobiose:

Cellobiose was tested at 4% in water, and found to be not sweet.

| | | | number | |
|---|---|---|---|---|
| Example | | cellobiose | of | |
| no | base | concentration | panelists | conclusion |
| 2 | zero fat greek | 50 ppm | 5 | masking some of |
| | yoghurt | | | astringency, |
| | | | | enhances body, |
| | | | | mouthfeel, |
| | | | | creaminess |
| 3 | artificially | 50 ppm | 5 | good masking, |
| | (aspartame/ | | | enhances body, |
| | AceK) | | | improves |
| | sweetened | | | mouthfeel, |
| | yoghurt | | | creaminess |
| 4 | low sugar | 50 ppm | 5 | sweeter, fuller, |
| | (50% reduction) | | | improved |
| | instant oatmeal | | | mouthfeel, richer, |
| | | | | creamier |
| 5 | low sugar | 50 ppm | 5 | adds body and |
| | (30% reduction) | | | mouthfeel, |
| | hot cocoa | | | improved quality |
| | | | | of sweetness |
| 6 | artificially | 50 ppm | 5 | more body, |
| | (aspartame/ | | | sweeter, nicer |
| | AceK) | | | quality of |
| | sweetened iced | | | sweetness, less |
| | tea | | | astringent |
| 7 | artificially | 50 ppm | 5 | masks lingering, |
| | sweetened | | | less artificial, less |
| | (sucralose) | | | bitter, more |
| | sweetened hot | | | mouthfeel |
| | cocoa | | | |
| 8 | black coffee | 50 ppm | 10 | reduced bitterness, |
| | | | | more mouthfeel |

### EXAMPLE 9

Effect of cellobiose at 30 ppm in low sugar instant oatmeal.

Six trained tasters evaluated low sugar instant oatmeal (33 g instant oats, 375 g of boiling water, 0.6 g of salt, 200 mesh and 9 g of sugar, mixed and consumed after sitting at least 2 minutes) and compared to the same low sugar instant oatmeal containing 30 ppm of cellobiose (12.5 mg) consiumed under identical conditions.

The instant oatmeal containing cellobiose was judged to be sweeter with fewer off-notes, and increased body and mouthfeel.

### EXAMPLES 10-17

Masking examples of psicose.

| | | | number | |
|---|---|---|---|---|
| Example | | Psicose | of | |
| no | base | concentration | panelists | conclusion |
| 10 | zero fat plain | 50 ppm | 5 | masking some, |
| | greek yoghurt | | | enhances body, |
| | | | | mouthfeel, |
| | | | | creaminess |
| 11 | Rebaudioside | 50 ppm | 5 | significant drop |
| | A sweetened | | | in off-notes, |
| | yoghurt | | | enhances body, |
| | | | | improves mouthfeel, |
| | | | | creaminess, sugar- |
| | | | | like sweetness |
| 12 | low sugar | 50 ppm | 5 | sweeter, fuller, |
| | (50% reduction) | | | improved mouthfeel, |
| | instant oatmeal | | | richer, creamier |
| 13 | low sugar | 50 ppm | 5 | adds body and |
| | (30% reduction) | | | mouthfeel, improved |
| | hot cocoa | | | quality of |
| | | | | sweetness |
| 14 | artificially | 50 ppm | 5 | more body, sweeter, |
| | (aspartame/ | | | nicer quality of |
| | AceK) | | | sweetness, less |
| | sweetened | | | astringent |
| | iced tea | | | |
| 15 | artificially | 50 ppm | 5 | masks lingering, |
| | sweetened | | | less artificial, less |
| | (sucralose) | | | bitter, more |
| | sweetened hot | | | mouthfeel |
| | cocoa | | | |
| 16 | black coffee | 50 ppm | 10 | reduced bitterness, |
| | | | | more mouthfeel |
| 17 | orange juice | 60 ppm | 10 | slightly sweeter, |
| | | | | improved mouthfeel |

### EXAMPLE 18

In a black coffee (drip method), cellobiose was tested at 1% for taste improvement. Samples were evaluated by a panel of expert tasters. Tasters were asked to compare the base (black coffee, regular strength, store brand) with the coffee to which cellobiose was added at 1% and report any change in taste observed. 5 out of 6 panelists reported reduction in bitterness.

### EXAMPLE 19

In a black coffee (drip method), cellobiose was tested at 4% for taste improvement. Samples were evaluated by a panel of expert tasters. Tasters were asked to compare the base (black coffee, regular strength, store brand) with the coffee to which cellobiose was added at 1% and report any change in taste observed. 4 out of 6 panelists reported dramatic reduction in bitterness, 6 out of 6 reported significant increase in sweetness.

### EXAMPLE 20

In store-brand instant coffee, cellobiose was tested at 4% for taste improvement. Samples were evaluated by a panel of expert tasters. Tasters were asked to compare the base (instant coffee, regular strength prepared according to the recommended dosage, i.e. 1 teaspoonful in a cup (240 ml) of water, with the instant coffee to which cellobiose was added at 4% and report any change in taste observed. 4 out of 6 panelists reported dramatic reduction in bitterness, 6 out of six reported increase in sweetness and 4 out of 6 reported increase in mouthfeel.

### EXAMPLE 21

In decaffeinated coffee (pods, Keurig type), cellobiose was tested at 4% for taste improvement. Samples were evaluated by a panel of expert tasters. Tasters were asked to compare the base (decaffeinated coffee, regular strength, store brand) with the coffee to which cellobiose was added at 4% and report any change in taste observed. 5 out of 6 panelists reported dramatic reduction in bitterness, 6 out of 6 reported significant increase in sweetness, and 4 out of 6 reported increase in mouthfeel.

### EXAMPLE 22

In order to understand whether the effect was due to the masking of caffeine alone, cellobiose was evaluated in caffeine.

Thus, cellobiose was tested at 4% for taste improvement in a solution containing 1000 mg caffeine/L. Samples were evaluated by a panel of expert tasters. Tasters were asked to compare the base (a solution of caffeine 1000mg/L in water) with a caffeine solution (10000 mg/L in water) to which cellobiose was added at 4% and report any change in taste observed. 5 out of 6 panelists reported dramatic reduction in bitterness.

### EXAMPLE 23

Preparation of flavor compositions.

The following ingredients were used:

| | Blend 1 (parts) | Blend 2 (parts) |
|---|---|---|
| Modified starch (Capsul ™) | 17 | 17 |
| Cellobiose | 15 | — |
| Psicose | — | 15 |
| Maltodextrin 10DE | 53 | 53 |
| d-limonene | 15 | 15 |

The ingredients of the two blends were each emulsified into an equal weight of deionised water. The resulting emulsions were spray-dried by spraying on a wheel atomizer spray drying machine (Anhydro PSD55), with inlet and outlet temperatures respectively at 163° C. and 94° C. The results in both cases were flavor granules of 20-30 micron mean diameter, ready for use in comestible products.

Although the embodiments have been described in detail through the above description and the preceding examples, these examples are for the purpose of illustration only and it is understood that variations and modifications can be made by one skilled in the art without departing from the spirit and the scope of the disclosure. It should be understood that the embodiments described above are not only in the alternative, but can be combined.

1. A method of masking off-tastes in a comestible composition, comprising the addition to a comestible composition base comprising high-intensity sweetener, of from 20-50 ppm of at least one of cellobiose and psicose.

2. The method according to claim 1, in which cellobiose alone is added.

3. The method according to claim 1, in which psicose alone is added.

4. The method according to claim 1, in which both cellobiose and psicose are added.

5. The method according to claim 1, in which the at least one of cellobiose and psicose is added as part of a flavor composition comprising at least one flavor-providing ingredient and at least one ancillary material.

6. A comestible composition comprising a comestible composition base, at least one sweetener and from 20-50 ppm of at least one of cellobiose and psicose.

7. The comestible composition according to claim 6, in which the at least one of cellobiose and psicose forms part of a flavor composition, comprising at least one flavor-providing ingredient and at least one ancillary material.

8. A method of reducing the off-notes of comestible products having reduced or no sugar content, comprising the addition to a comestible composition base of an off-note-masking proportion of cellobiose and/or psicose.

9. The method according to claim 8, in which the comestible product is selected from oatmeal, yoghurt, especially zero-fat yoghurt, cocoa and orange juice.

10. The method according to claim 8, in which the comestible product is coffee.

11. The method according to claim 8, in which the cellobiose and/or psicose forms part of a flavor composition, comprising at least one flavor-providing ingredient and at least one ancillary material.

12. A reduced-sugar or no-sugar comestible product containing no high-intensity sweetener, comprising a comestible product base and an off-note-masking proportion of cellobiose and/or psicose.

13. The comestible product according to claim 12, selected from oatmeal, yoghurt, zero-fat yoghurt, cocoa and orange juice.

14. The comestible product according to claim 12, in which the comestible product is coffee.
